(19) United States
(12) Patent Application Publication
(10) Pub. No.: US 2017/0164598 A1
(43) Pub. Date: Jun. 15, 2017

(54) Pasty Pesticide Applicator and Applying Method Thereof

(71) Applicant: NEK Chemicals Limited, Hong Kong (HK)

(72) Inventor: Wing Ngai Ng, Hong Kong (HK)

(21) Appl. No.: 15/348,977

(22) Filed: Nov. 10, 2016

(30) Foreign Application Priority Data
Dec. 9, 2015 (CN) 201510904017.4

(51) Int. Cl. A01M 1/20

(52) U.S. Cl. CPC A01M 1/2055

(57) ABSTRACT

The present invention relates to a pasty pesticide applicator, comprising a cavity for containing pasty pesticide, an ointment base mounted inside the cavity and bonded together with pasty pesticide, and a screw for driving the ointment base to move along the inner wall of the cavity. One end of the screw is inserted into the inside of the cavity and the other end is outside the cavity and connected to a rotary handle. During application of pesticide, the operator removes the cap of the applicator from the cavity, rotates the rotary handle or the cavity to push the pasty pesticide in the applicator out of the cavity, holds the cavity in hand and directly smears the pasty pesticide on the target applying positions. The pesticide applying device provided by the present invention is characterized by safe use, simple structure, easy storage and portability.

### CROSS REFERENCE TO RELATED APPLICATIONS

The present application claims the benefit of Chinese Patent Application No. 201510904017.4 filed on Dec. 9, 2015. All the above are hereby incorporated by reference.

### TECHNICAL FIELD

The present invention relates to the technical field of plant protection and hygienic pest control, particularly to a pasty pesticide applicator and applying method thereof.

### DESCRIPTION OF THE BACKGROUND

Currently, common pesticide products are mostly in a liquid or semisolid state. Liquid pesticide is packed in a spray can. During use, it may be sprayed out under the propulsion of compressed gas. As the sprayed gas is mostly combustible and is sprayed out in mist, the product has potential hazards of combustion and explosion and will also contaminate non-target positions due to inaccurate targeting.

Semisolid pesticide does not have a fixed shape and generally is packed in a squeezable tube or a hard package with a cylinder. During use, the tube is squeezed or a piston is pushed to squeeze the ointment in the cylinder. The extruded ointment will stay at the release position by relying on its own adhesive force. However, this product is mostly used for hygienic pest control and the use is singular. Further, as it is a semisolid ointment, if the package is wrongly squeezed or the application is not careful, ointment may fall to non-target surface, causing contamination.

There are some products for plant wound care. One of the methods is to cover plant wounds with wax to isolate the wounds from the outside world and play a protective role, but in this method, no appropriate pesticide is added and the care effect is poor; another wound care product containing pesticide is a coating similar to paint preparation. During application, this paint preparation is smeared on the target object, but as it is a liquid product, it is liable to splash and contamination of non-target surface.

### SUMMARY OF THE INVENTION

To address the foregoing defects or shortcomings of prior art, the object of the present invention is to provide a pesticide product with “hold and use” characteristic to reduce use risk and environmental impact.

In order to realize the foregoing object, the present invention adopts the following technical scheme:

On the one hand, the present invention provides a pasty pesticide applicator, comprising a cavity for containing pasty pesticide, an ointment base mounted inside the cavity and bonded together with pasty pesticide, and a screw for driving the ointment base to move along the inner wall of the cavity. One end of the screw is inserted into the inside of the cavity and the other end is outside the cavity and connected to a rotary handle.

As a modification scheme of the applicator, the ointment base comprises a base plate and a sleeve inserted to the base plate and having internal thread. The screw passes through the sleeve and fits with the internal thread of the sleeve to realize stretch-out and draw-back of the ointment base.

As a modification scheme of the applicator, the applicator further comprises a cap, which covers the ointment discharge end of the cavity and may be sleeved on the rotary handle.

As a modification scheme of the applicator, stripes are designed on the external surface of the cap to increase friction force.

Another object of the present invention is to provide a pesticide applying method of the pasty pesticide applicator, including the following steps: removing the cap of the applicator from the cavity, rotating the rotary handle or the cavity, and driving the ointment base to move relatively along a screw inside the cavity and push pasty pesticide in the applicator out of the cavity; holding the cavity in hand and directly smearing pasty pesticide to the target applying positions; after application, reversely rotating the rotary handle or the cavity to take the pasty pesticide into the cavity.

Meanwhile, after the cap is removed, it may be sleeved on the rotary handle to increase torque of the rotary handle and friction force during rotation to make for rotation of the rotary handle.

Compared with prior art, the pasty pesticide applicator provided by the present invention is both a product package and an ointment applying tool. The operator only needs to hold the packing tube (i.e. cavity), push out ointment in a rotational way and smear the ointment to the target applying positions. After application, the ointment is drawn back to the packing tube in a rotational way. In the pesticide applying method provided by the present invention, the operator does not need to directly contact the ointment in the whole application process. The applicator is characterized by safe use, simple structure, easy storage and portability.

Below the present invention will be further described by referring to embodiments and accompanying drawings.

### BRIEF DESCRIPTION OF THE DRAWINGS

FIG. 1 is a structural schematic of a pasty pesticide applicator provided by an embodiment of the present invention;

FIG. 2 is a section view of the applicator as shown in FIG. 1;

FIG. 3 is an exploded schematic view of the applicator as shown in FIG. 1;

FIG. 4 is a schematic view of application preparation of a pasty pesticide applicator provided by the present invention;

FIG. 5 is a schematic view of ointment pushout of a pasty pesticide applicator provided by the present invention during application;

FIG. 6a is a schematic view of ointment smearing of a pasty pesticide applicator provided by the present invention during application;

FIG. 6b is an alternative schematic view of ointment smearing of a pasty pesticide applicator provided by the present invention during application.

### DETAILED DESCRIPTION OF PREFERRED EMBODIMENTS

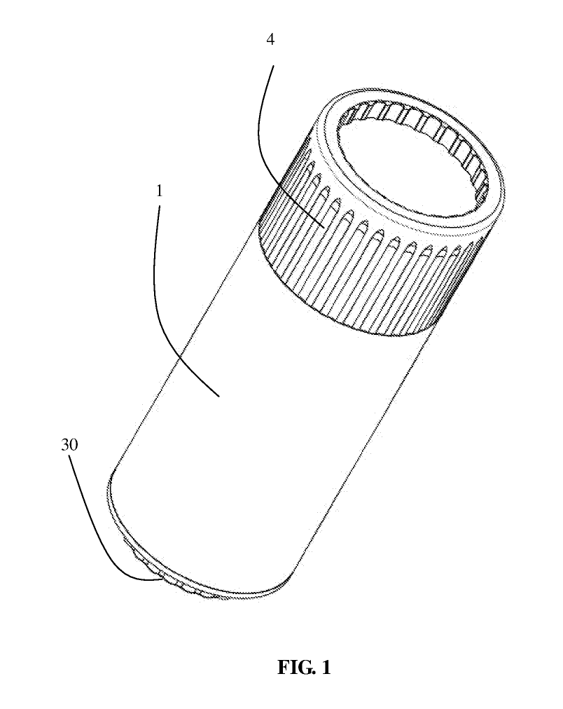

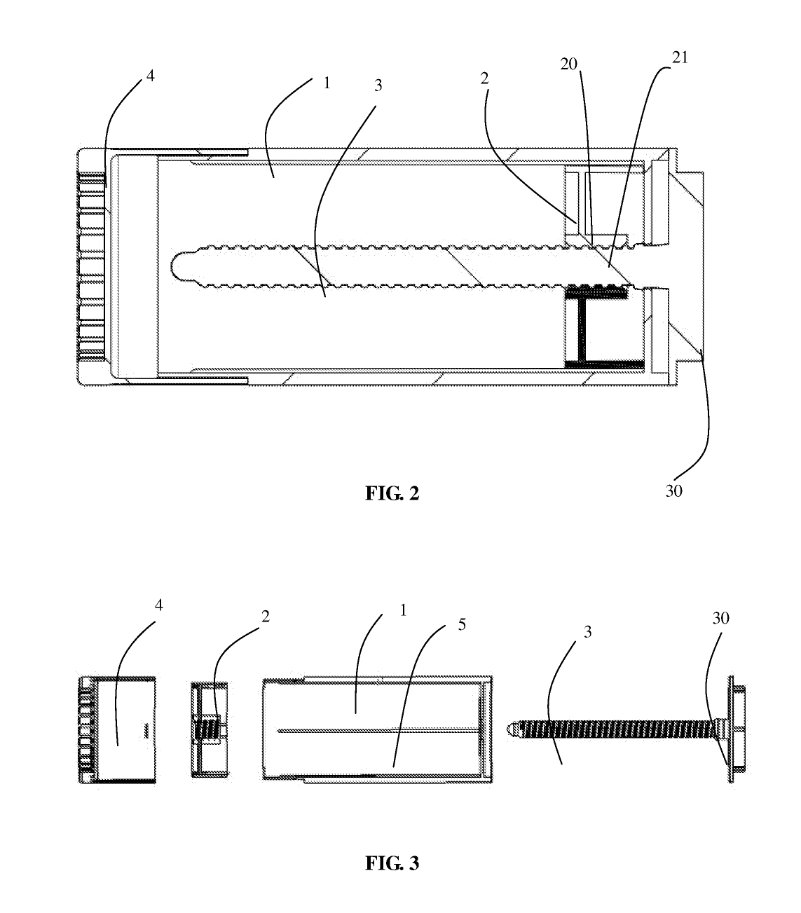

FIG. 1, FIG. 2 and FIG. 3 show a pasty pesticide applying device, comprising a cavity 1, an ointment base 2, a screw 3 and a cap 4. The cavity 1 is tubular and intended to contain pasty pesticide and comprises a first end and a second end. The first end of the cavity 1 is open. The pasty pesticide may stick out of cavity 1 from the first end. The ointment base 2 is mounted to the second end of the cavity 1. The ointment base 2 comprises a base plate 20 and a sleeve 21 inserted to the middle position of the base plate 20 and having internal thread. The screw 3 passes through the cavity 1 and the sleeve 21 from the second end of the cavity 1 and fits with the internal thread of the sleeve 21. The other end of the screw 3 is located outside the cavity 1 and connected to a rotary handle 30. By rotating the rotary handle 30, the ointment base may be moved from the second end of the cavity 1 to the first end or be drawn back from the first end of the cavity 1 to the second end, i.e.: stretch pasty pesticide out of the cavity 1 or draw it back into the cavity 1. As a preferred scheme, the screw 3 is inserted into the cavity 1 from the second end of the cavity 1 and extends till the second end of the cavity 1, or in other words, the length of the screw 3 is close to the length of cavity 1.

The cap 4 covers the first end of the cavity 1 and is intended to seal pasty pesticide in the cavity 1 to protect it from contamination. During application by the pesticide applying device, the cap 4 is pulled out from the first end of the cavity 1. The cap 4 is sleeved onto the rotary handle 30 to increase the contact area of the handheld location during rotation of the screw 3, making for rotation of the rotary handle 30 and preventing loss of the cap 4.

In this embodiment, the pesticide applying device further comprises a strut 5 mounted on the cavity wall of the second end of the cavity 1 in a fixed manner. The strut 5 is coaxial with the screw 3 and intended to support the screw 3.

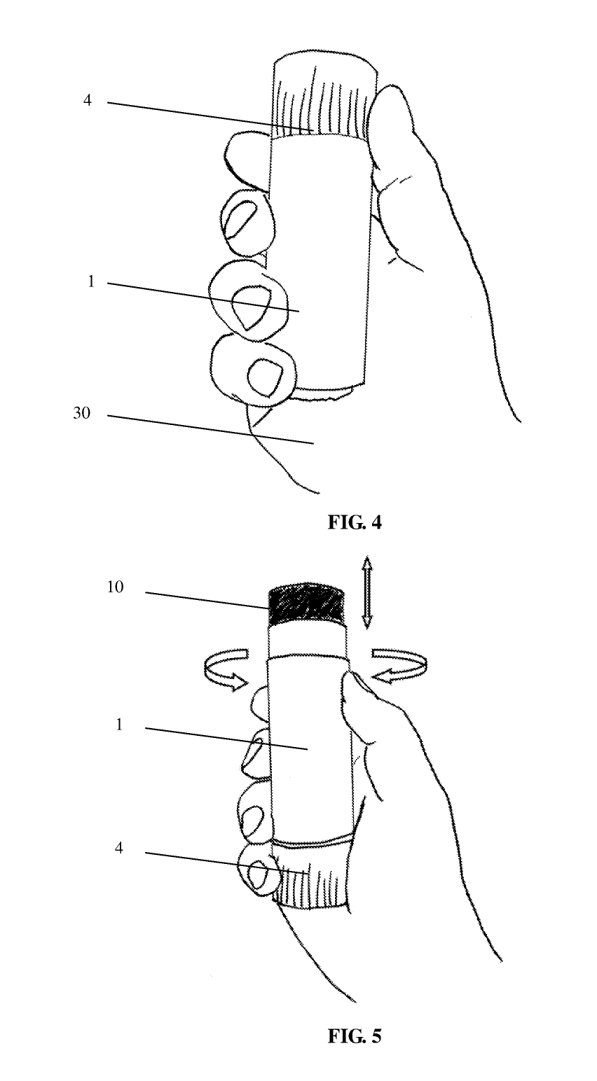

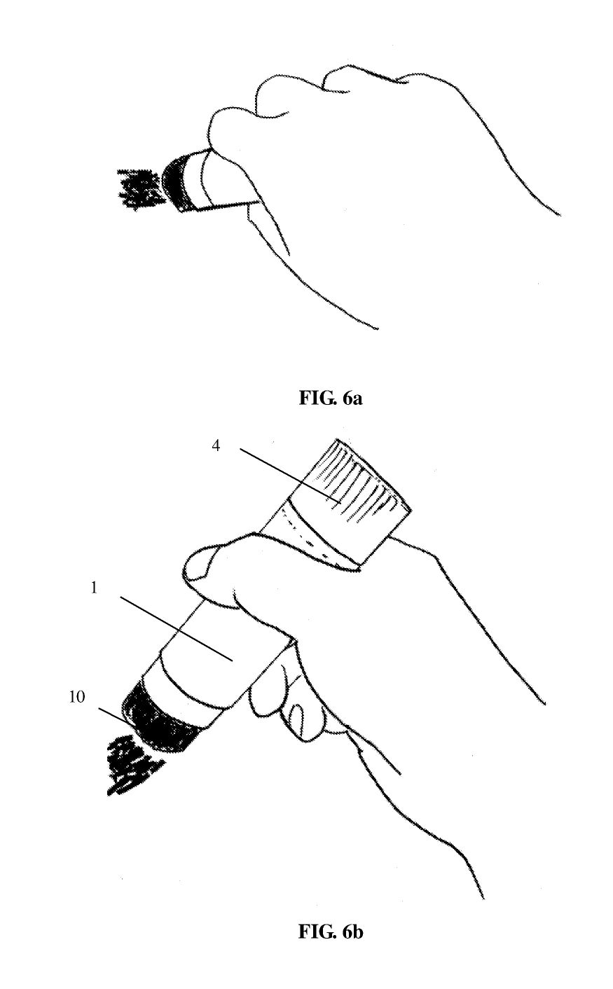

As shown in FIGS. 4, 5, 6a and 6b, during use, the target object for application of pesticide is found at first, the applicator is taken out and the cap 4 of the applicator is removed from the cavity. The cap 4 may be sleeved onto the rotary handle 30 to increase the torque of the rotary handle 30 and friction force during rotation, thereby making for rotation of the rotary handle 30, then the rotary handle 30 or the cavity 1 is rotated to drive the ointment base to move relatively along the screw inside the cavity and push the pasty pesticide 10 out of the cavity 1 from the applicator;

The cavity 1 is held in hand, and the pasty pesticide 10 is directly smeared to the target applying position;

After application, the rotary handle 30 or the cavity 1 is rotated reversely to take the pasty pesticide 10 into the cavity 1.

The foregoing embodiments are only a few embodiments of the present invention. Their descriptions are concrete and detailed, but they shall not be therefore understood as limitations to the scope of the present invention patent. It shall be noted that for those skilled in the art, various changes and modifications may be made to the embodiments without departing from the spirit of the present invention, such as: combinations of different features of the embodiments. All these shall be in the protective scope of the present invention.

What is claimed is:

1. A pasty pesticide applicator, comprising a cavity for containing pasty pesticide, an ointment base mounted inside the cavity and bonded together with pasty pesticide, and a screw for driving the ointment base to move along the inner wall of the cavity; one end of the screw being inserted into the inside of the cavity and the other end being outside the cavity and connected to a rotary handle.

2. The applicator according to claim 1, wherein the ointment base comprises a base plate and a sleeve inserted to the base plate and having internal thread; the screw passing through the sleeve and fitting with the internal thread of the sleeve to realize stretch-out and draw-back of the ointment base.

3. The applicator according to claim 1, wherein the applicator further comprises a cap, which covers an ointment discharge end of the cavity and may be sleeved on a rotary handle.

4. The applicator according to claim 1, wherein stripes are designed on the external surface of the cap to increase friction force.

5. A pesticide applying method of the pasty pesticide applicator of claim 1, including the following steps:
removing the cap of the applicator from the cavity, rotating the rotary handle or the cavity, and driving the ointment base to move relatively along a screw inside the cavity and push pasty pesticide in the applicator out of the cavity;
holding the cavity in hand and directly smearing pasty pesticide to the target applying positions;
after application, reversely rotating the rotary handle or the cavity to take the pasty pesticide into the cavity.

6. The pesticide applying method according to claim 5 further comprising removing the cap and sleeving it onto the rotary handle to make for the rotation of the rotary handle.
